(19) United States
(12) Patent Application Publication
(10) Pub. No.: US 2007/0214005 A1
(43) Pub. Date: Sep. 13, 2007

(54) Medical account system and method

(75) Inventor: Beverly Kennedy, Greenwood Village, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/368,301

(22) Filed: Mar. 3, 2006

(51) Int. Cl. G06Q 10/00; G06Q 20/00; G06Q 40/00

(52) U.S. Cl. 705/2; 705/16; 705/39

(57) ABSTRACT

A system and method for enabling a benefactor to help pay the costs of medical items of a consumer, such as a family member or friend. The benefactor funds a stored value account. A medical card that identifies the account is issued to the consumer. The card is presented to a medical provider or retailer where items are being purchased. A POS terminal is used to enter information concerning the consumer and the purchased item. Coverage under medical plans is determined, and any amount not covered by the medical plans many be paid for using the card.

### CROSS-REFERENCES TO RELATED APPLICATIONS

NOT APPLICABLE STATEMENT AS TO RIGHTS TO INVENTIONS MADE UNDER FEDERALLY SPONSORED RESEARCH OR DEVELOPMENT

NOT APPLICABLE REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

Healthcare costs have become a significant burden for many people, including senior citizens. While the Medicare system in the Untied States provides basic medical care for senior citizens, and supplemental coverage may be available through “Medigap” insurance, Medicaid, and other programs, senior citizens and other people receiving medical care often find themselves in the position of having to pay “out-of-pocket” for uncovered services, prescriptions, deductibles and the like.

Some medical services and brand name pharmaceuticals may involve very high out-of-pocket expenses, particularly when purchased on a frequent basis (e.g., pharmaceuticals that need to be taken regularly). Many times, family or friends of people taking medication (or having other medical expenses) are willing to help defray the cost, but it may be difficult to help for various reasons. For example, in some instances the patient may be reluctant to ask for a direct “handout” from others, and in other instances the patient may not even know on the exact amount needed to cover an out-of-pocket expense (the “out-of-pocket” portion of a medical expense may not be known until after a claim has been processed by a medical plan (Medicare, Medicaid, private insurance, etc.).

### BRIEF SUMMARY OF THE INVENTION

There is provided, in accordance with various embodiments of the invention, a system and method for paying medical costs, and in particular, to a system and method for paying costs not covered by medical plans from a stored value account that is funded by a benefactor.

In one embodiment, there is provided a system and method for paying for medical costs of a consumer that may not be able to pay such costs, by establishing a stored value account, where value in the account is funded by a party (individual or entity) other than the consumer, entering at a POS device identifying data for a medical plan to be used in connection with the medical costs, using the identifying data to determine the amount of the costs covered under the medical plan, and using the stored value account to pay for any balance of the cost not covered under the medical plan.

In some embodiments, a presentation instrument (e.g., card) is used by the consumer to access the stored value account.

### BRIEF DESCRIPTION OF THE DRAWINGS

FIG. 1 is a general schematic diagram showing a system for facilitating payments from a stored value account, in accordance with one embodiment of the invention.

FIG. 2 illustrates a medical card that may be used by an individual to offset medical costs, with the card being used in conjunction with the system of FIG. 1.

FIG. 3 illustrates a screen display at one of the POS terminals in the system of FIG. 1.

FIG. 4 is a flow diagram illustrating the operation of the system of FIG. 1.

### DETAILED DESCRIPTION OF THE INVENTION

There are various embodiments and configurations for implementing the present invention. Generally, embodiments provide systems and methods for enabling a benefactor to fund a stored value account, represented in one example by a medical card. The account (and card) are used by a consumer to offset the cost of pharmaceuticals and other medical services or goods that are not covered (either partially or in full) by a medical plan.

Some embodiments of the invention use a POS (“point of service” or “point of sale”) terminal where the consumer presents the card when paying for medical costs incurred for services or goods provided by a medical provider. While in exemplary embodiments an elderly person may use a medical card in accordance with the invention in order to offset the out-of-pocket costs of pharmaceuticals not covered by Medicare, Medicaid or other medical plans, it should be appreciated that the invention will have broader application. For example, the medical card could be used by a consumer of any age (student, disabled person, etc.) that is unable for any reason to pay medical costs not covered by a medical plan. In addition, the card could be used to cover the cost of any medical service or good from a medical provider. Thus, the term “provider” is intended to encompass any person or entity that provides a health-related service/good to a patient or consumer, including a physician (or other healthcare professional), clinic, hospital, treatment center, medical testing laboratory, pharmacy, dispensary, store having health-related goods, and the like.

Embodiments of the present invention permit a benefactor, such as a relative of a elderly person needing financial assistance in paying for pharmaceuticals, to provide a medical card to a recipient (consumer) that can be used to offset medical costs. The medical card may be presented by the consumer to a medical provider (such as a pharmacy) to pay any out-of-pocket costs that are not covered by a medical plan. The card may be used at a POS terminal to identify the consumer (and the benefactor-funded account). It may also be used to identify medical plans under which the consumer is covered, so that only a single card/identification needs to be presented. The card permits the consumer to pay for pharmaceuticals and other medical goods/services without the embarrassment of asking a relative for help each time an expense arises. The card may be presented as a “gift” to the consumer, so that it does not have the stigma of a cash “handout”.

In some embodiments, the entire transaction (including the determination of coverage under a medical plan and the payment of any balance with the card account) can be handled on a real-time, on-line basis, using identifying data stored on the card in order to access consumer/account information at a remote database. This obviously makes for greater efficiency and for earlier payment to the provider, but also makes the transaction less objectionable to the consumer (there is no need to call a family member to make arrangements for payment of out-of-pocket expenses). Furthermore, the card may be issued by the provider (e.g., pharmacy) as a convenience to family members wanting to help an elderly parent or other family member in need, and may encourage the use of that provider over others not offering a similar card. The card could also be issued by an entity serving as a pharmacy benefits manager, in order to handle out-of-pocket payments apart from a traditional financial or credit card network.

There are many possible methods for funding/loading the card. For example, the card may be funded by the benefactor in person when visiting a retail establishment, or could be funded over the telephone or internet (using a bank account or credit card). The card can also be reloaded in the same fashion, or reloaded automatically (e.g., when the card balance drops to a predetermined level, or at established intervals, say, every ninety days).

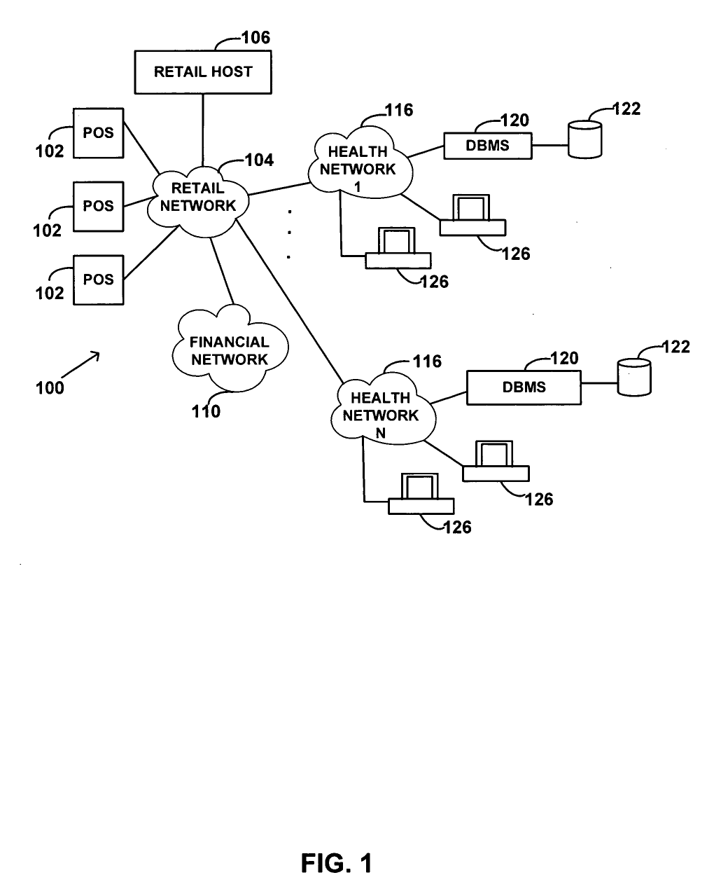

Turning now to FIG. 1, there is illustrated one embodiment of the invention. A system 100 includes a plurality of point-of-sale (POS) terminals 102 connected to a retail network 104. The network 104 is of a well known type, wherein the POS terminals 102 may be located at one (or more) retail establishments (pharmacies, drug stores, grocery stores, etc.). The POS terminals have price look-up and other functionality, either internally or through interconnection to a retail host 106 through retail network 104. The retail network may also be connected to a banking or financial network 110. The financial network 110 handles credit card and other electronic transactions passing through the retail network 104, e.g., originating at the POS terminal. The retail network 104 may also be connected to a plurality of health account networks 116, to be described later.

Terminals (such as the POS terminals 102) used for conducting retail and similar transactions are well known. Although not illustrated in FIG. 1, such terminals may include a keyboard, a display and various peripheral devices or functions (e.g., magnetic stripe card reader, optical bar code reader, etc.) well know to those skilled in the art. As should also be appreciated, the POS terminals may be operated by a retail clerk when products to be purchased are presented by a customer at a checkout line, or could be self-service terminals used by the customer, without intervention by a retail clerk (e.g., at a checkout station, built into a shopping basket, or located elsewhere within a retail establishment).

In such systems, when products are taken by a customer to the POS terminal 102, product information or a product ID is entered (e.g., at a keyboard or through use of a bar code scanner). Product information is used to retrieve pricing information (e.g., at a price look-up table within the POS terminal, in a database maintained within a retailer host 106, or at a remote database maintained by a health network 116). The customer may use cash or a financial card (e.g., credit card), and in the case of a credit card, information may be read at the POS terminal (e.g., at a magnetic stripe reader) and transmitted to a bank or financial institution through financial network 110 in order to authorize the transaction and post it to the appropriate account. The credit card may be presented at any time during the transaction (before, during or after) product IDs are entered. POS devices and networks for conducting credit card and similar transactions are known and can be found in co-pending, commonly assigned U.S. patent application Ser. No. 10/116,689, entitled “SYSTEMS AND METHODS FOR PERFORMING TRANSACTIONS AT A POINT-OF-SALE,” filed Apr. 3, 2002, by Earney Stoutenburg, et al., which is a continuation-in-part of U.S. patent application Ser. No. 09/634,901, entitled “POINT OF SALE PAYMENT TERMINAL,” filed Aug. 9, 2000, by Randy J. Templeton et al. Further, such devices and terminals used in connection with health insurance plans and medical savings accounts are found in co-pending, commonly assigned U.S. patent application Ser. No. 10/675,929, entitled “SYSTEMS AND METHODS FOR VERIFYING MEDICAL INSURANCE COVERAGE,” filed Sep. 29, 2003, by Charles Whitaker, et al., U.S. Provisional Pat. App. No. 60/515,918, entitled “HEALTH CARE ELIGIBILITY VERIFICATION SYSTEMS AND METHODS,” filed Oct. 29, 2003, by Judi Gabel et al., and U.S. patent application Ser. No. 10/839,769, entitled “SYSTEM AND METHOD FOR CONDUCTING TRANSACTIONS WITH DIFFERENT FORMS OF PAYMENT,” filed May 4, 2004, by Steve Randall et al. The entire disclosures of the referenced patent applications are hereby incorporated by reference.

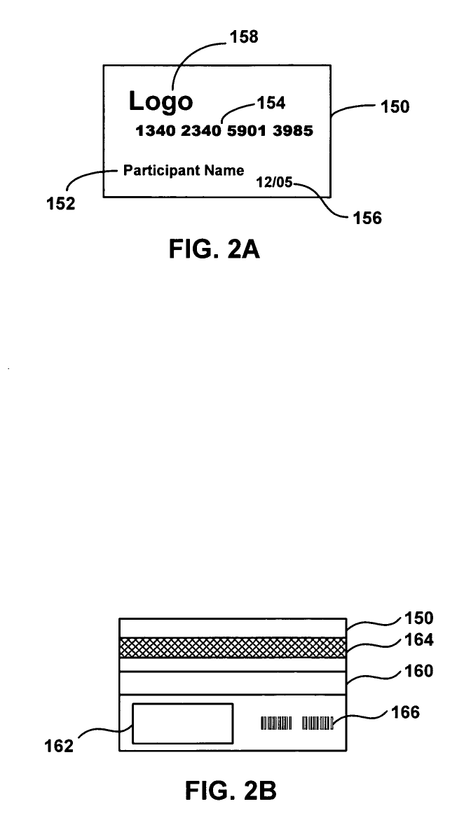

The health account networks 116 provide two major functions, namely (1) managing medical plans (health insurance, health maintenance organization (HMO), pharmacy benefit manager (PBM), Medicare, Medicaid, etc.), and (2) managing medical accounts that are funded by benefactors and that are administered by a retailer, financial firm or other or other institution that establishes and maintains accounts and issues medical cards (in some cases, one entity—e.g., PBM—may manage a medical plan and also separately manage medical accounts). In particular, it is anticipated that a customer uses a funded medical card (to be described later in conjunction with FIGS. 2A and 2B) to identify himself and an account to which the cost of medical items may be applied. Such information is entered (e.g., by reading a magnetic stripe on the medical card at one of the POS terminals 102), and is communicated through the retail network 104 to any one or more of the health networks 116. For example, an identifier on the card will enable the system 100 to direct product information (e.g., pharmaceutical identification) to any one of the health networks administering a medical plan that covers the participant. Thus, if the consumer is Medicare-eligible, the system 100 directs information on a pharmaceutical being purchased to a specific network 116 that handles inquiries/claims for medical items that are subject to Medicare coverage (and likewise other healthcare networks that administer claims under other medical plans). The cost of the pharmaceutical may or may not be covered (either in part or in full), and the healthcare network returns information to the POS terminal (to be described in greater detail later) that can inform the retailer (and consumer) of the amount of the item's cost (if any) that is covered under Medicare and/or other medical plans. Systems for providing medical plan coverage information on pharmaceuticals and other medical services/goods are known and described in co-pending and commonly assigned U.S. Provisional Pat. App. No. 60/696,268, entitled “HEALTHCARE SYSTEM AND METHOD FOR REAL TIME CLAIMS ADJUDICATION AND PAYMENT,” filed Jul. 1, 2005, by Renee Elahi-Lutzen et al., and U.S. Provisional Pat. App. No. 60/696,269, entitled “HEALTHCARE SYSTEM AND METHOD FOR RIGHT TIME CLAIMS ADJUDICATION AND PAYMENT,” filed Jul. 1, 2005, by Renee Elahi-Lutzen et al., both of which are hereby incorporated by reference. In addition to accessing networks 116 for medical plan information, if the card is issued to a person having a medical account (funded by a benefactor), an account identifier is transmitted to a separate one of the networks 116 where account information (balance, eligibility requirements, etc.) can also be returned to the POS terminal 102.

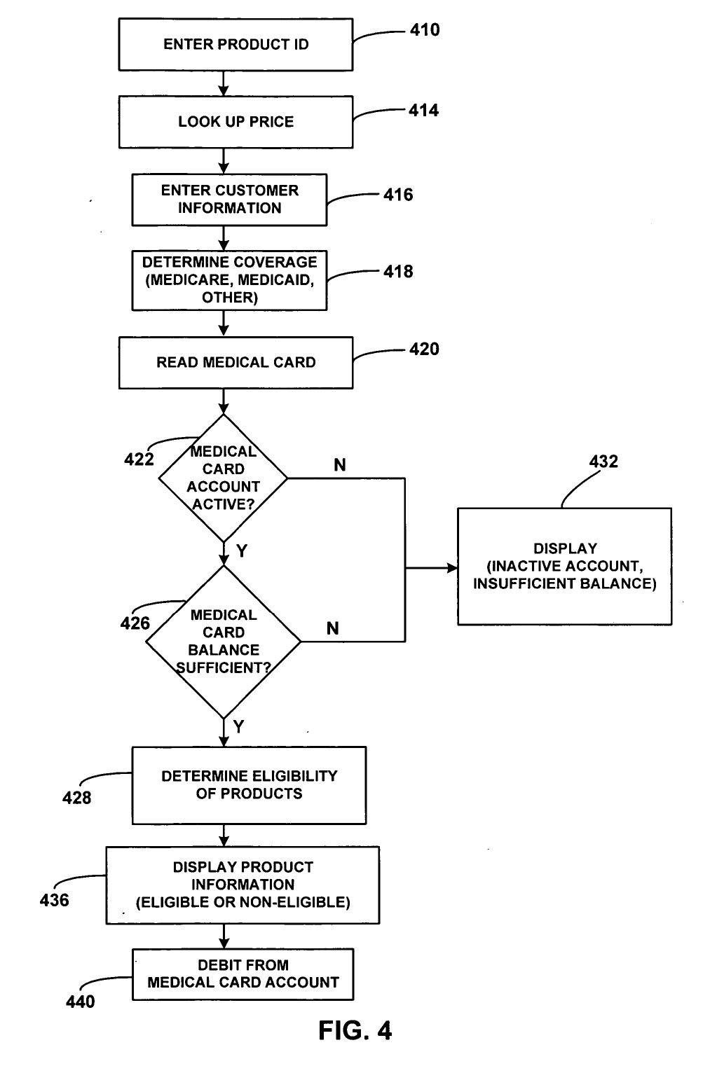

Each health network 116 links systems, terminals and databases operated by a plan or account administrator, including a database management system or server (DBMS) 120 which manages an associated data store or database 122, and terminals 126. The database 122 stores data (to be described in greater detail later in conjunction with FIG. 4) which may, among other things, identify plan participants, account balances, and product IDs for eligible products. The DBMS 120 and database 122 may include any one of numerous forms of storage devices and storage media, such as solid state memory (RAM, ROM, PROM, and the like), magnetic memory, such as disc drives, tape storage, and the like, and/or optical memory, such as DVD. The database 122 may be co-located with the DBMS 120, it may be integral with the DBMS 120, or it may represent (with DBMS 120) distributed data systems located remotely in various different systems and locations. The terminals 126 are workstations used, for example, by administrative staff when accessing the DBMS 120 and other systems connected to the network 116.

The networks 104, 110 and 116 maybe implemented using the Internet, an intranet, a wide area network (WAN), a local area network (LAN), a virtual private network, or any combination of the foregoing. The networks may include both wired and wireless connections, including optical links. For example, the POS terminals may be portable wireless terminals (stationary or mobile) linked to the retail network 104 by wireless communications channels.

While each of the networks 104, 110 and 116 is illustrated in FIG. 1 as a separate network, all could in fact be a single, integrated network (maintained by a financial institution that both processes financial transactions from merchant locations and administers one or more plans). Alternatively, the networks 104, 110 and 116, could each be multiple networks. For example, the financial network 110 could represent multiple bank networks connected to the retail network 104 so card transactions for accounts maintained at any one of several different banking or financial institutions may be processed. Furthermore, while for purposes of the present description the systems maintaining the funded medical accounts are illustrated as one of the health networks 116, such accounts could maintained within the financial network 110.

Also, while the POS terminals 102, retailer host 106, DBMS 120 and database 122 are illustrated as separate devices or systems geographically distributed across various networks, they (and their functionality) could all be collocated at a single location and could even all be integrated into a single computing system or device.

FIGS. 2A and 2B show the front and back sides, respectively, of a presentation instrument or medical card 150 that could be used by a customer (e.g., as a debit card) when purchasing pharmaceuticals (or other goods or services) at one of the POS terminals 102, according to one embodiment of the invention. For purposes of the present description, it is assumed that the customer presents the card 150 after purchases have been brought to the POS terminal and each product ID number has been entered (e.g., by use of a keyboard or optical bar code reader). However, the medical card may be presented at any time (e.g., before, during or after product ID's have been entered.)

The card 150 is used to identify the participant (as someone covered under a benefactor-funded medical card account, and provide information to the POS terminal 102 in order to verify eligibility and/or settle transactions. One side of the card may be embossed with the participant's name 152, an account number 154, and an expiration date 156. The card may have a logo 158 of the payer (retailer or other medical plan administrator).

The back side of the card may include a signature line 160, and plan information 162. Plan information may include a group number, a plan administrator phone number, and other similar information. In some embodiments, the card 150 may optionally serve also as an insurance or other medical plan ID and could include information such as deductibles, co-payments, and the like.

The card also includes one or more information encoding features. Information encoding features may include a magnetic stripe 164, a bar code 166, a smart chip (not shown), and the like. It is to be understood that many other examples of a presentation instrument and associated information encoding features are possible.

In the illustrated embodiment, the card number 154 identifies the institution maintaining the account as well as the customer's individual account. Similar to conventional credit or debit card transactions, such information is used by the POS terminal and retail network 104 to route the transaction data to the health networks 116, where the account or other customer information (e.g., medical plan information) is accessed (to be more fully described later).

The system 100 conveniently permits the benefactor (or the retailer or other institution maintaining the medical card account) to establish criteria or restrictions as to the goods or services that are eligible for payment through the account. For example, after the product ID for each product to be purchased is entered at POS terminal 102, and after participant information (account number, etc.) is read from the card at the POS terminal 102, such information is transmitted through retail network 104 to the health network 116 (and its associated DBMS 120) maintaining the card account. The DBMS 120 accesses database tables in the associated database 122 that have the participant's account information and also information concerning eligible products. The customer is then informed at the POS terminal 102 whether individual purchases are eligible for payment and whether there are sufficient moneys in the account to pay for eligible purchases. As should be appreciated, this permits the benefactor to designate the card for specific medical purchases, for categories of products (e.g., for pharmaceuticals, but not over-the-counter medicines), for any medical purchases (as opposed to non-medical purchases), etc.

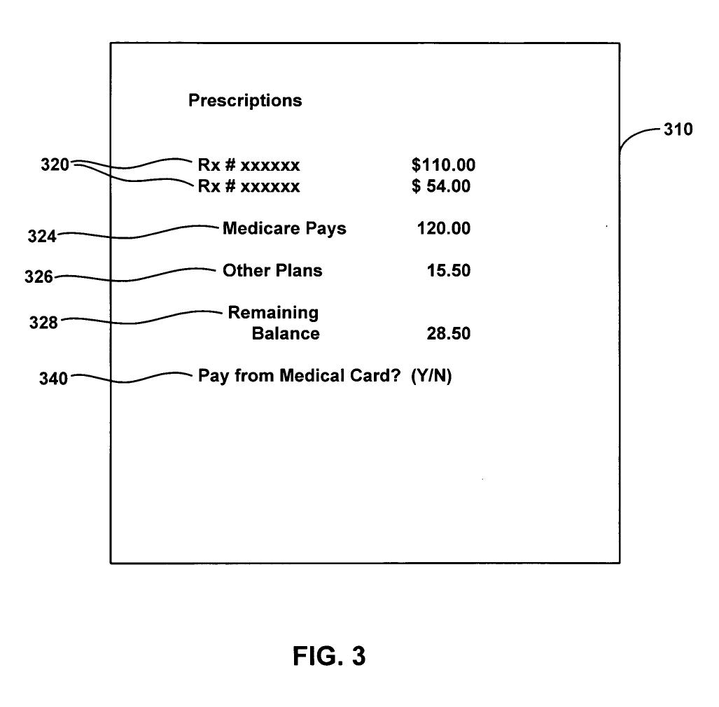

FIG. 3 illustrates a screen 310 that could be displayed at one of the POS terminals 102. The screen 310 facilitates the purchase of products (for example, prescribed pharmaceuticals purchased at a drug store) by displaying the products and their purchase price, the extent to which the prescription may be covered under any medical plans of the participant, and the remaining balance that may be paid for using the funded medical card account.

As seen in FIG. 3, various prescriptions have been presented (and their product IDs read) at the POS terminal 102. Those products and their prices are displayed. Further, the customer has presented a card (such as the card 150 seen in FIG. 2), and the eligibility of purchases for medical plan coverage has been determined (the various steps for such determination will be described later). Thus in FIG. 3, the screen 310 displays the purchased products 320 and, assuming the person is Medicare eligible, the amount 324 covered under Medicare. If the participant has other insurance, the amount (if any) covered under those other plans is displayed at 326, and the remaining balance at 328. The participant (whose has been identified by accessing a database 122 as having a funded medical account) is asked through use of the display (at display line 340) whether eligible products are to be debited against the medical account. Upon selection for medical account payment (such as by use of a keyboard or a touch screen entry), the account is debited. The payments from the funded account to the retail establishment or merchant are handled in the same manner as a conventional debit card transaction, with the amount debited from the account being electronically transferred through a clearing house network (e.g., financial network 110) and credited to the account of the merchant.

Of course, if a purchase is not eligible for payment using the funded account, the customer is responsible for payment (cash, check, credit card, etc.).

While not illustrated in the drawings, in addition to displaying the purchase amount for each eligible product, the screen 310 may also display a discounted participant price for other items purchased at the same time as prescriptions. The discounted price may, for example, be provided by the retailer as a benefit to participants, whereby eligible items may not only be conveniently paid out of the funded account, but also those items or other (e.g., non-eligible) items may purchased at a reduced price. Such an arrangement may be attractive to the retail merchant as an incentive for customers having funded accounts to shop at that merchant's stores.

It should be appreciated that information other than that seen in FIG. 3 could also be displayed on screen 310 (e.g., name of the participant, his/her account number, the remaining balance in the funded account, etc).

Turning to FIG. 4, when the customer brings a pharmaceutical (or other medical product) to be purchased to the POS terminal 102, the product ID (e.g., from a bar code) is entered at the POS terminal, step 410, and the terminal accesses, step 414, a price-look up table (at the POS terminal 102, retail host 106 elsewhere within retail network 104) in order to retrieve a price and, if desired, other information such as a product name, etc. At step 416, customer identification account information is entered at the POS terminal, which along with the product information may be sent to the health networks 116 for those plans that cover the participant. While not described in connection with FIG. 1, the retailer host 106 may contain information on each participant to enable the POS terminal 102 to determine which plans (Medicare, Medicaid, private insurance) cover the participant, step 418, and accordingly which of the health networks 116 need to be accessed to determine the specific amounts covered. Alternatively, plan information as well as medical account information may be contained on medical card 150, and when the card is read at step 422 (to identify the medical card account), medical plan identifiers (Medicare, Medicaid, private insurance IDs) may be read at the same time.

It should be appreciated that the process of FIG. 4 assumes that a medical card account has been earlier established for the participant. As part of that process, a benefactor (family member, friend, or other interested party) sets up the account with the account administrator, and funds the account with an initial amount (and periodically reloads the card account later, if needed or desired), and establishes any conditions or restrictions that pertain to use of the card (e.g., what kind of items may be purchased, dollar limits, locations where the card may be used, etc.), and the account administrator then issues the card 150 to the participant.

Returning to FIG. 4, after the transaction data (e.g., product ID) and the medical card account information (e.g., account number on the card 150) has been entered, it is sent through the heath network 116 (that manages medical card accounts) to its associated DBMS 120, so that the corresponding database 122 may confirm that the account is present and active (step 422), and may determine whether the balance in the account is sufficient to cover the purchase of eligible products, step 426. If the account is not active or there is insufficient balance, information to that effect is displayed at the terminal 102, step 432. Next, DBMS 120 determines at step 428 whether products being purchased are eligible for purchase according to the pre-established conditions or restrictions maintained with the account information.

If the account is active and has a sufficient balance, then the information in screen 310 seen in FIG. 3 is displayed at POS terminal 102, step 436, in order for the customer to see which products are covered under which plans and the amounts that are covered. The customer elects whether to have any remaining balanced paid for using the medical card 150, at step 440.

While not shown in FIG. 4, a printer associated with the POS terminal 102 could print information concerning the transaction (including the information shown on the display 310 of FIG. 3) on a receipt that is provided to the participant after the purchase is completed.

It should be appreciated that the flow diagram in FIG. 4 is only one example of a process that could be carried out by application programs within the system 100. Additional steps may be performed, some steps may be omitted, and the order of illustrated steps may be changed. For example, additional screens could be displayed to lead the customer/clerk through the transaction. Depending on the account plan, there may not need to be an eligibility determination (step 428). Also, the medical card 150 could be presented and account information read before any product information is entered at the POS terminal.

It should be appreciated from the preceding discussion that the present invention provides a novel method and system for enabling a benefactor to assist a person in the purchase of medical goods or services. While detailed descriptions of presently preferred embodiments of the invention have been given above, various alternatives, modifications, and equivalents will be apparent to those skilled in the art without varying from the spirit of the invention. For example, while the described embodiments relate to a dedicated card for use in paying uncovered balances on eligible products, the medical account information could be associated with an existing credit, debit, financial, insurance or other card. For example, if the participant has an existing credit card, the financial network 100 could include a look-up table to relate the medical account (and insurance plans) to the credit card information, so that when the credit card is read, the POS terminal can be provided with other account and plan information from the financial network. Thus the customer/participant may avoid having to carry additional cards.

Further, the participant need not carry a card at all. Rather the presentation instrument could be an RFID (radio frequency identification device) which is carried by the customer (e.g., as a key fob) and which electronically transmits medical account information when passed near a transceiver at the POS terminal, so that the entire transaction can be conducted without presenting or reading/swiping a card. As a further example, the presentation instrument need not be a tangible instrument at all, but could be a “virtual card,” i.e., simply an identifier or password issued by the medical account administrator (e.g., a string of characters) that a customer has memorized and that could be entered (along with an optional security code/PIN) at the POS terminal whenever a transaction is to be conducted.

Therefore, the described embodiments should not be taken as limiting the scope of the invention, which is defined by the appended claims.

What is claimed is:

1. A method for paying for medical costs of a consumer that may not be able to pay such costs, the method comprising:
establishing a stored value account, where value in the account is funded by a party other than the consumer;
obtaining identifying data for a medical plan to be used in connection with the medical costs;
using the identifying data to determine the amount of the costs covered under the medical plan; and
using the stored value account to pay for any balance of the cost not covered under the medical plan.

2. The method of claim 1, wherein the step of using the stored value account includes:
providing a presentation instrument to the consumer that identifies the stored value account; and
presenting the presentation instrument at a POS terminal in order to pay any balance not covered under the medical plan.

3. The method of claim 2, wherein the presentation instrument is a card bearing electronically readable data identifying the stored value account.

4. The method of claim 3, wherein the medical plan may include one of more of Medicare, Medicaid and private insurance.

5. The method of claim 4, further comprising:
providing a processing system for determining the amount of the costs to be covered under the medical plan.

6. The method of claim 5, wherein the card further identifies the consumer and the medical plan, and wherein the processing system uses the identification of the consumer and the medical plan to determine the costs to be covered under the medical plan.

7. The method of claim 6, wherein the processing system determines the amount to be covered by:
first determining coverage, if any, under Medicare, then
determining coverage, if any, under Medicaid, then
determining coverage, if any, under private insurance, and then
applying value from the stored value account to any balance of the cost.

8. A system for use in paying costs associated with medical goods or services provided to a consumer, the system comprising:
a POS terminal for entering identifying data associated with the consumer and with the goods or services, in order to determine the cost of such goods or services, a medical plan covering the consumer, and any amount of the costs not covered under the medical plan;
a database for storing data representing a pre-paid value associated with an account, the pre-paid value contributed by a benefactor for use in paying medical costs of the consumer; and
a database management system for applying value from the account to pay at least a portion of the balance of the cost not paid under the medical plan, in order to provide financial assistance to the consumer in connection with the cost.

9. The system of claim 8, wherein the consumer is issued a presentation instrument bearing the identifying information, and the identifying information is read from the presentation instrument.

10. The system of claim 9, wherein the presentation instrument is a card.

11. The system of claim 10, wherein the POS terminal includes a card reader for electronically reading the identifying information from the card.

12. The system of claim 8, wherein the POS terminal includes a display, and wherein information regarding the coverage under the medical plan is provided to the display.

13. The system of claim 12, wherein information concerning any amount not covered under the medical plan is provided to the display to enable the consumer to elect to have such amount paid for using the account.

14. A method for paying the cost of medical goods or services of a consumer where the consumer may not have the means to fully pay such cost, comprising:
providing a POS terminal;
establishing the cost of the goods or services at the POS terminal;
entering identifying information at the POS terminal for at least one source of payment under a medical coverage plan;
determining the amount to be paid for the goods or services under the medical coverage plan;
determining any balance owed for to the goods or services that is not paid under the medical coverage plan;
entering information from a stored value card having value funded by an individual other than the consumer; and
using the stored value card pay the balance owed for the goods or services.

15. A method for paying medical costs incurred by a consumer, where the consumer has a medical coverage plan that may cover only a portion of medical costs, the method comprising:
establishing a stored value account, the stored value account funded at least in part by someone other than the consumer;
using a processing system to apply the medical plan to the costs in order to determine the amount, if any, of the medical costs that are not covered under the medical plan; and
using the stored value account to pay the amount not covered by the medical plan.

16. The method of claim 15, wherein the stored value account is funded as a gift from a family member of friend of the consumer.
